(19) United States
(12) Patent Application Publication
(10) Pub. No.: US 2015/0134419 A1
(43) Pub. Date: May 14, 2015

(54) CUSTOMER EXPERIENCE MANAGEMENT (CEM) METRICS AND OPERATIONAL CORRELATION TECHNIQUES

(71) Applicant: AT&T Intellectual Property I, L.P., Atlanta, GA (US)

(72) Inventors: Veeramani Kandasamy, Annandale, NJ (US); James G. Beattie, JR., Bergenfield, NJ (US); Douglas Stewart, Woodstock, GA (US)

(73) Assignee: AT&T Intellectual Property I, L.P., Atlanta, GA (US)

(21) Appl. No.: 14/076,623

(22) Filed: Nov. 11, 2013

(51) Int. Cl. G06Q 30/02

(52) U.S. Cl. CPC G06Q 30/0205
USPC 705/7.34

(57) ABSTRACT

A mechanism is provided for corresponding network collected metrics to user equipment collected metrics is provided. Customer experience management (CEM) data is retrieved for an event obtained directly from computing devices of customers in a geographical area. The CEM data was stored at the computing devices. The computing devices wirelessly operate on a wireless communication network. CEM data obtained from the computing devices is averaged to determine a CEM data average value. Network data is retrieved for the event obtained from a node in the geographical area on the wireless communication network, and the network data was stored at the node. Network data obtained from the node is averaged to determine a network data average value for the network data. The network data average value is correlated to CEM data average value to determine a relationship between the network data average value and CEM data average value for the event.

### BACKGROUND

The present disclosure relates generally to customer experience management (CEM) metrics, and more particularly, to customer experience management (CEM) metrics and relationships that affect an entity's net promoter score for the services rendered via the user equipment (UE).

The net promoter score (NPS) is a customer loyalty metric. NPS can be as low as −100 (everybody is a detractor) or as high as +100 (everybody is a promoter). An NPS that is positive (i.e., higher than zero) is considered to be good, and an NPS of +50 is excellent. The net promoter score measures the loyalty that exists between a provider and a consumer. The provider can be a company, an employer, or any other entity. The provider is the entity that is asking the questions on the NPS survey. The consumer is the customer, employee, or respondent to an NPS survey. NPS is based on a direct question such as: How likely are you to recommend our company/product/service to your friends and colleagues? The primary purpose of the NPS methodology is to evaluate customer loyalty to a brand or company, not to evaluate their satisfaction with a particular product or transaction.

### BRIEF SUMMARY

Exemplary embodiments include a method of corresponding network collected metrics to user equipment collected metrics. The method includes retrieving customer experience management data for an event obtained directly from computing devices of customers in a geographical area. The customer experience management data has been stored at the computing devices. The computing devices wirelessly operate on a wireless communication network. The method includes averaging the customer experience management data obtained from the computing devices to determine a customer experience management data average value, retrieving network data for the event obtained from a node in the geographical area on the wireless communication network, and averaging the network data obtained from the node to determine a network data average value for the network data. The network data has been stored at the node. The network data average value is correlated to the customer experience management data average value to determine a relationship between the network data average value and the customer experience management data average value for the event.

Other exemplary embodiments include an apparatus. The apparatus includes a processor and memory comprising computer-executable instructions that, when executed by the processor, cause the processor to perform operations. The operations includes retrieving customer experience management data for an event obtained directly from computing devices of customers in a geographical area, where the customer experience management data has been stored at the computing devices. The computing devices wirelessly operate on a wireless communication network. The operations include averaging the customer experience management data obtained from the computing devices to determine a customer experience management data average value, retrieving network data for the event obtained from a node in the geographical area on the wireless communication network, and averaging the network data obtained from the node to determine a network data average value for the network data. The network data having been stored at the node. The operations also include correlating the network data average value to the customer experience management data average value to determine a relationship between the network data average value and the customer experience management data average value for the event.

Other exemplary embodiments include a computer program product, tangibly embodied on a computer readable medium, for corresponding network collected metrics to user equipment collected metrics. The computer program product includes instructions that, when executed by a processor, cause the processor to perform operations. The operations include retrieving customer experience management data for an event obtained directly from computing devices of customers in a geographical area, wherein the customer experience management data has been stored at the computing devices. The computing devices wirelessly operate on a wireless communication network. The operations include averaging the customer experience management data obtained from the computing devices to determine a customer experience management data average value, retrieving network data for the event obtained from a node in the geographical area on the wireless communication network, and averaging the network data obtained from the node to determine a network data average value for the network data. The network data has been stored at the node. The operations also include correlating the network data average value to the customer experience management data average value to determine a relationship between the network data average value and the customer experience management data average value for the event.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF EXEMPLARY EMBODIMENTS

Referring now to the drawings wherein like elements are numbered alike in the several FIGURES:

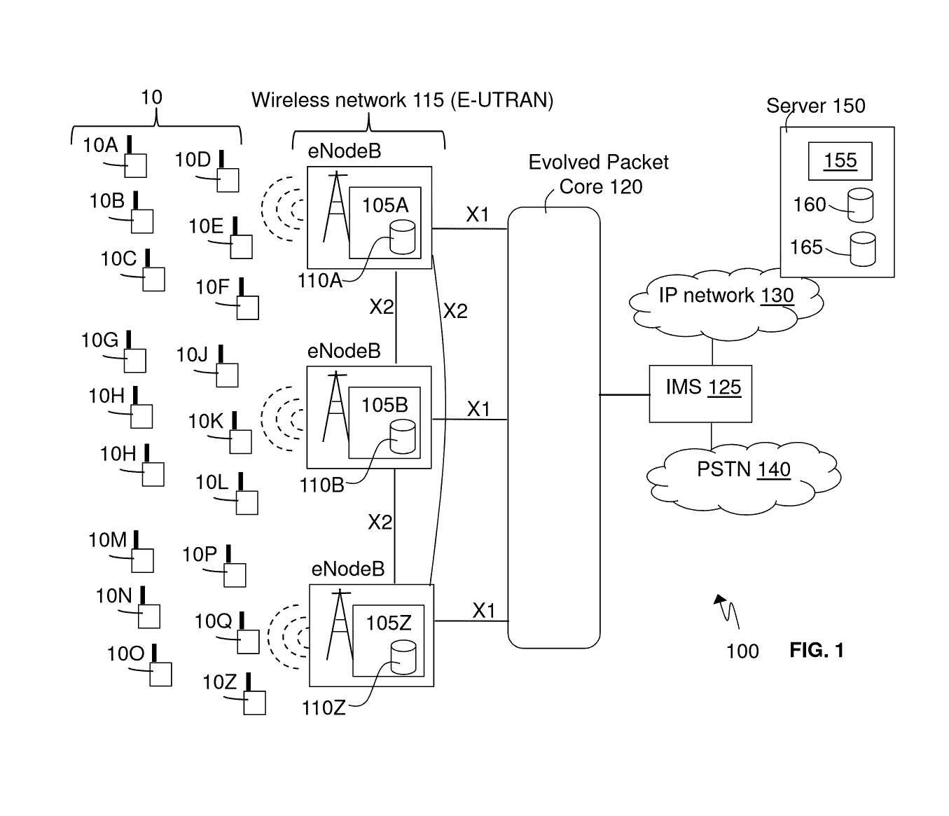

FIG. 1 illustrates a wireless communication network and system according to an exemplary embodiment;

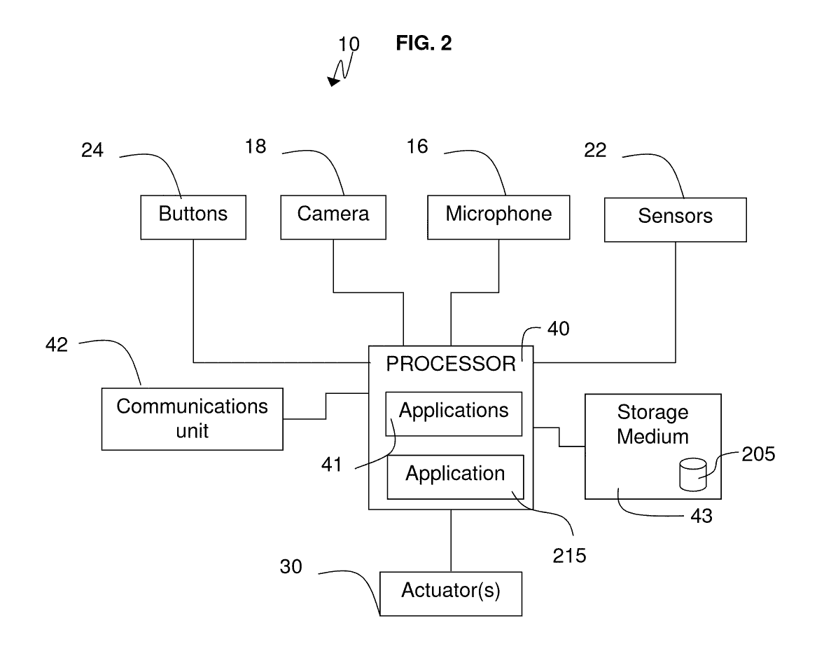

FIG. 2 illustrates a mobile device according to an exemplary embodiment;

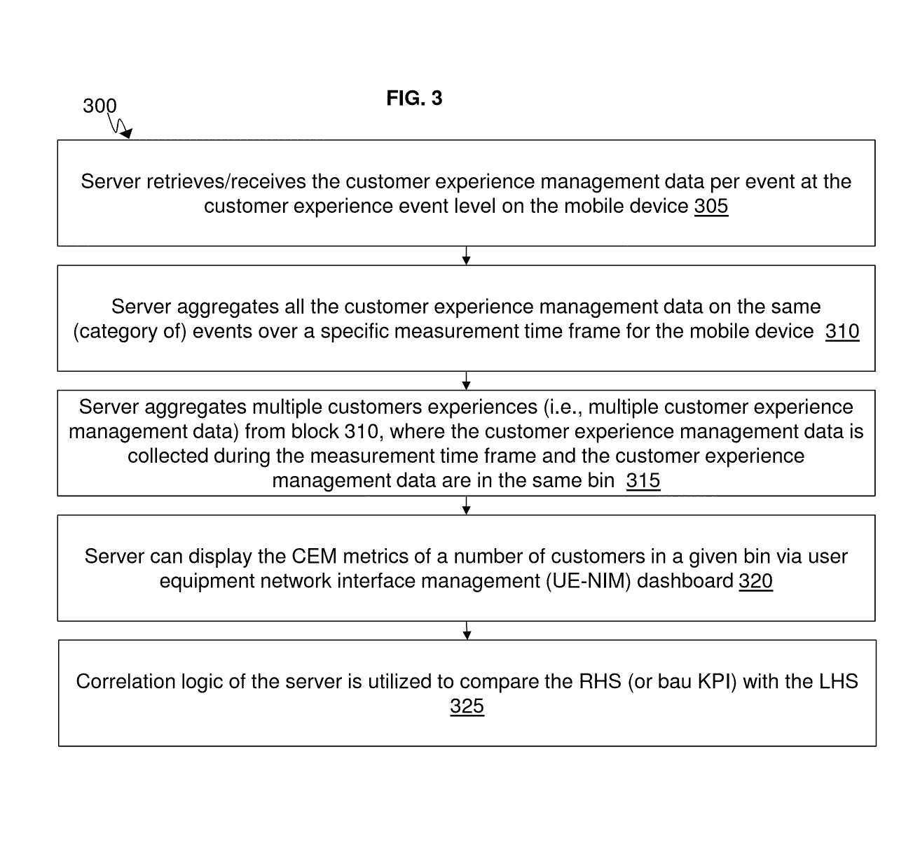

FIG. 3 is a flowchart of a process for developing the left hand side (LHS) of an equation and corresponding the LHS to the right hand side (RHS) according to an exemplary embodiment;

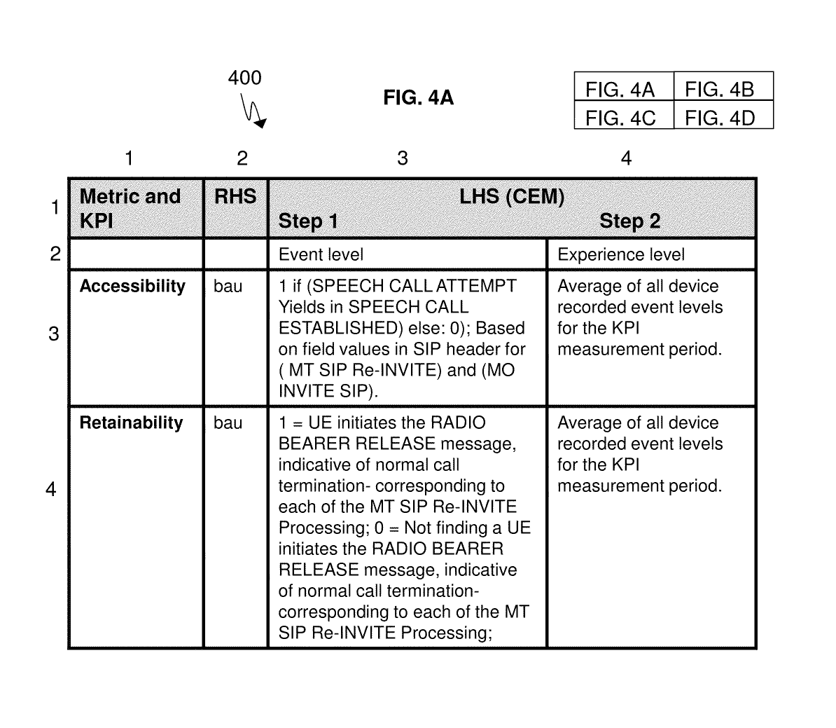

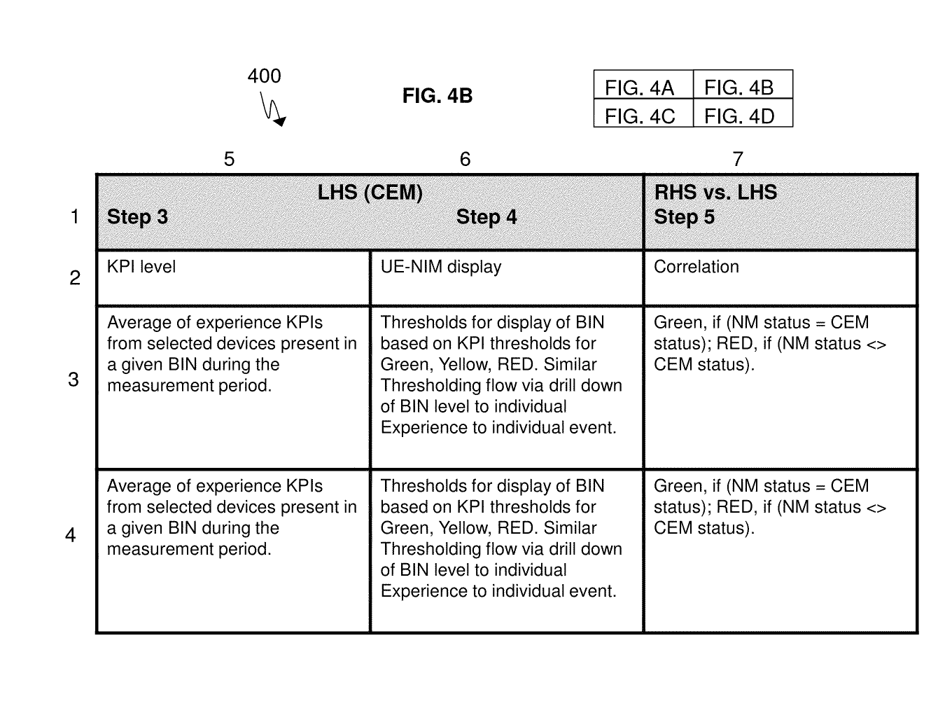

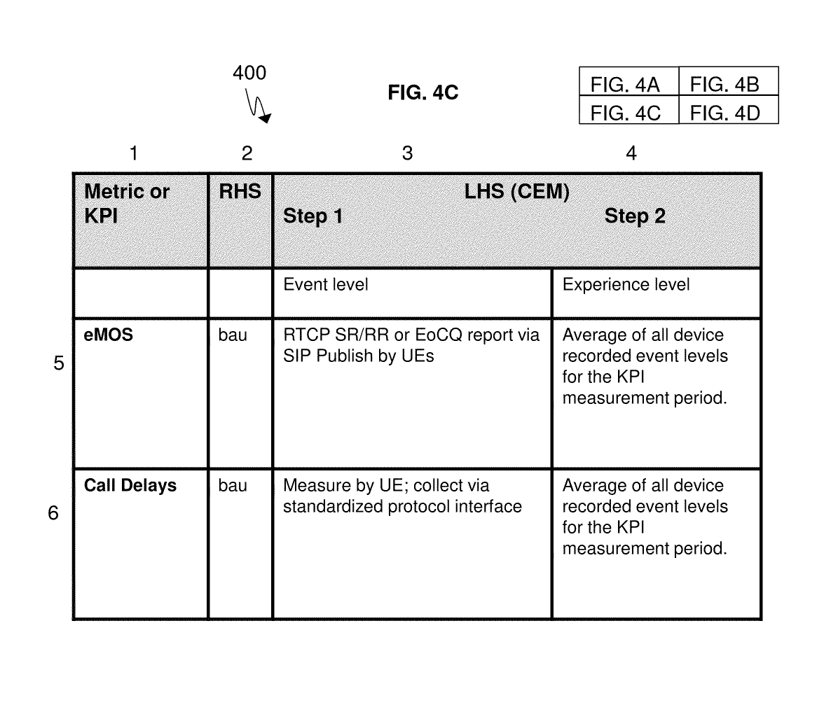

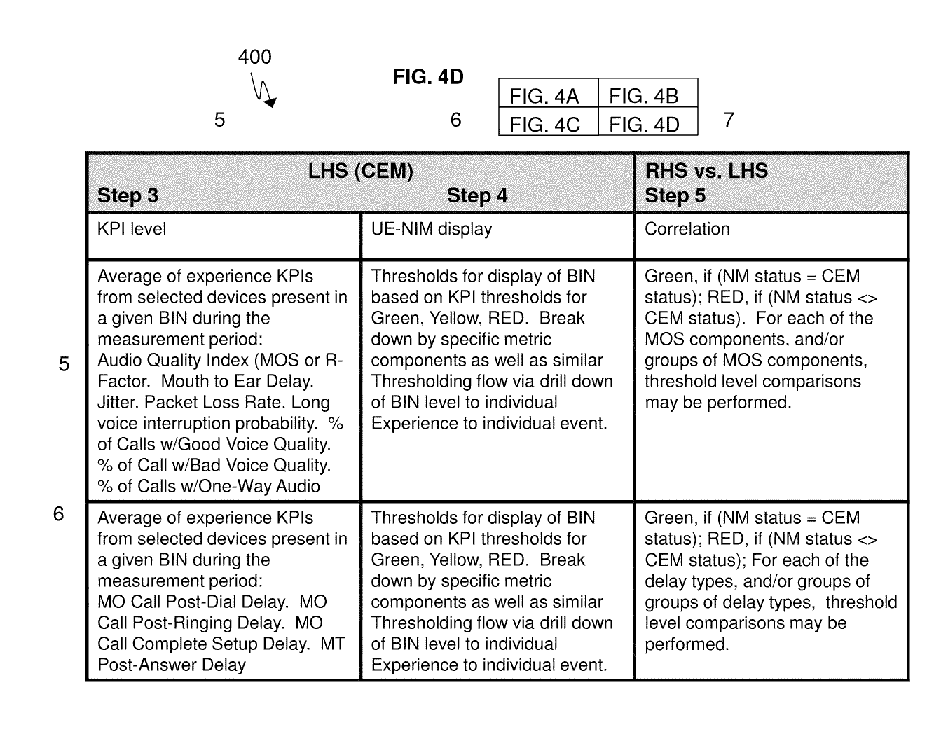

FIGS. 4A, 4B, 4C, and 4D together illustrate a chart developing the left hand side (LHS) of the equation and corresponding the LHS to the right hand side (RHS) according to an exemplary embodiment;

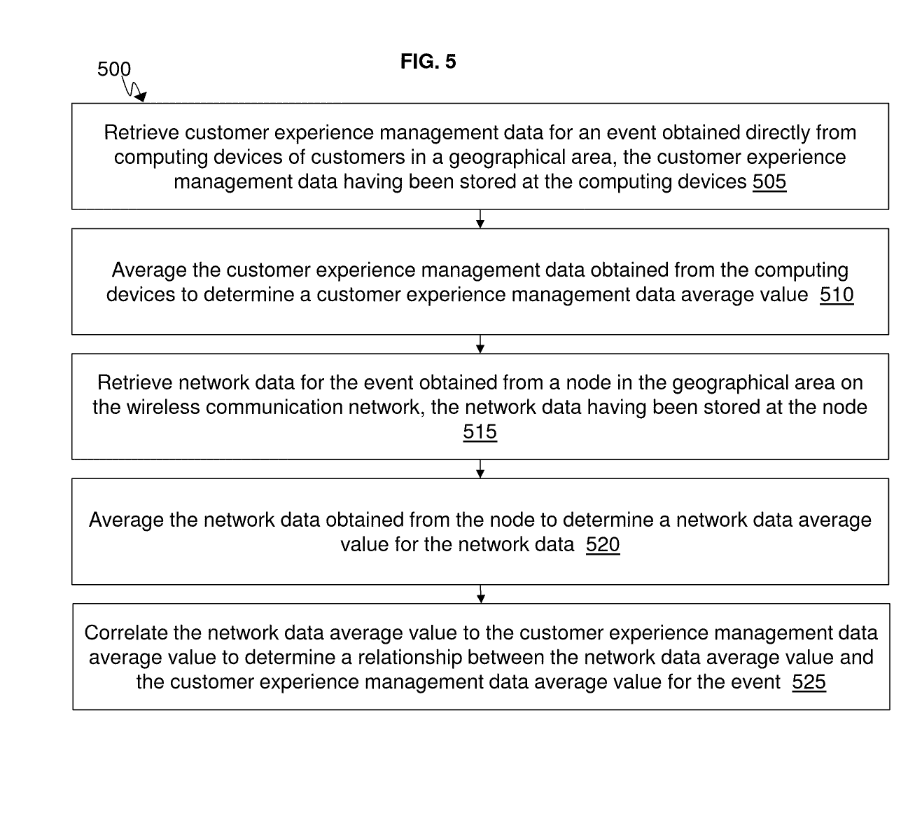

FIG. 5 is a flowchart of a process for corresponding network collected metrics to user equipment collected metrics in an exemplary embodiment; and

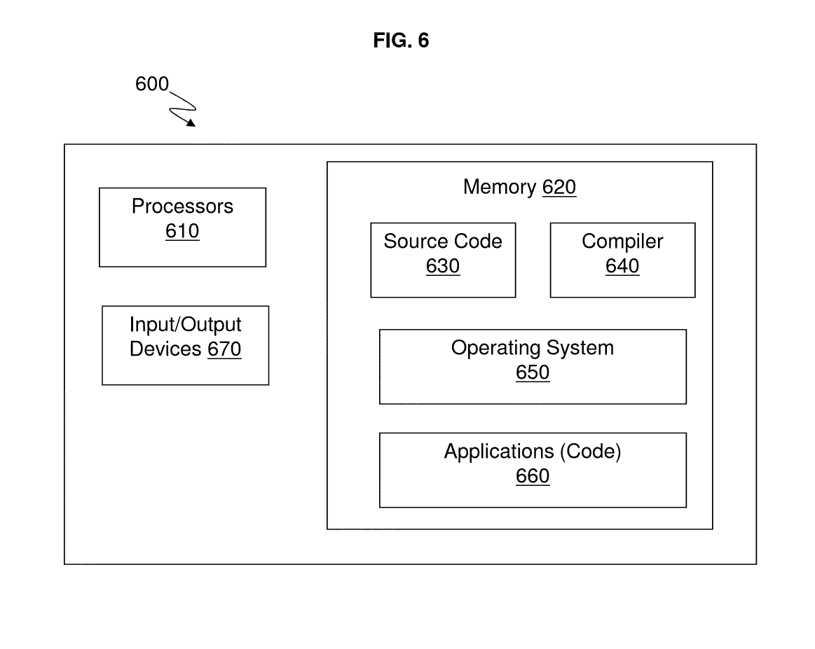

FIG. 6 illustrates an example of a computer having capabilities and features which may be included and/or incorporated in exemplary embodiments.

The detailed description explains the exemplary embodiments, together with advantages and features, by way of example with reference to the drawings.

### DETAILED DESCRIPTION OF DRAWINGS

According to exemplary embodiments, customer experience management (CEM) metrics and methods are provided to elevate the net promoter score for the services (e.g., provided by an entity such as AT&T®) rendered via the user equipment (UE). Data generated at the user equipment, which corresponds to the services as experienced by the customer via the same UE, are gathered with the customer's consent. Such data are received at and processed by an exemplary “User Experience Network Impairment Management” system. The computational methods for CEM metrics (obtained/collected directly from the user equipment) along with the logical methods for their correlation to the business as usual (BAU) network and services key performance indicators (KPIs) are disclosed herein.

FIG. 1 illustrates a wireless communication network and system 100 according to an exemplary embodiment. The system 100 illustrates an example of a voice over long term evolution (VoLTE) network for explanation purposes and not limitation, and exemplary embodiments apply to other network standards as understood by one skilled in the art.

The system 100 includes numerous mobile devices 10. The mobile devices 10 are individually shown as mobile devices 10A through 10Z but are generally referred to as mobile devices 10. The mobile devices 10 are the user equipment of the customer/user, and the mobile devices 10 communicate with the wireless network 115 to receive the network services. The wireless network 115 may include various eNode Bs each with its own antenna and computer equipment 105. The computer equipment 105 (connected to the antenna) may include power amplifiers, digital signal processors, backup batteries, etc., and the computer equipment 105 includes a transceiver for communicating with the mobile devices 10 (via the antenna). Also, the computer equipment 105 of each eNode B may include the functionality of a base station controller and radio network controller. The eNode B is known as an E-UTRAN Node B or evolved Node B. The eNode B is the hardware (i.e., antenna and computer equipment 105) that communicates directly with the mobile devices 10 as understood by one skilled in the art. Also, each eNode B can communicate (wirelessly or wired) with one another over an X2 interface, which is an interface that allows all eNode Bs to be linked together.

Each eNode B may be connected to an evolved packet core (EPC) 120 via an X1 (or S1) interface. The evolved packet core 120 serves as the equivalent of GPRS networks. The evolved packet core 120 includes a mobility management entity, serving gateway, PGW (PDN) gateway, home subscriber server (HSS), access network discovery and selection function, (ANDSF), and evolved packet data gateway (ePDG) as understood by one skilled in the art.

The evolved packet core 120 is connected to an Internet Protocol multimedia subsystem (IMS) 125, which is an architectural framework for delivering Internet Protocol (IP) multimedia services via UTRAN and E-UTRAN.

The IMS 125 may be connected to an IP network 130 and PSTN 140. The IP network 130 may include a server 150 of the entity (such as AT&T®) providing the services to the mobile devices 10.

A service provider (such as AT&T®) employs highly sophisticated and integrated KPIs representing all aspects of the network and services (e.g., stored in database 160) provided to the customers via the respective mobile devices 10. However, in conventional systems, few if any quantifiable metrics reflecting the same capabilities and services as received and experienced by the customer via the UE (mobile device 10) exist. As a result, direct correlation of customer experience to the BAU KPIs in the database 160 is not possible. Such a correlated understanding of customer experience and operational KPIs may be considered important to improve capabilities so as to uplift the customer controlled Net Promoter Scores. Accordingly, embodiments disclosed herein may be utilized to address these issues which include how to directly correlate user device level customer experience (e.g., retrieved/collected from each individual mobile device 10 and stored in database 165 as customer experience management data) with corresponding network and service operational views (e.g., retrieved from the computer equipment 105 of each eNode B and stored in database 160 as network data).

Each respective mobile device 10 has its own software application 215 in addition to other software applications 41 for operating the mobile device 10 as shown in FIG. 2. The customer experience management (CEM) metrics are collected and stored (by the software application 215 in a mobile device database 205) in each respective mobile device 10 to then be sent to and/or retrieved by application 155 of the server 150. FIG. 2 depicts the mobile device 10 according to an exemplary embodiment. Mobile device 10 may be a phone, tablet, personal digital assistant, etc., equipped with communications components (e.g., cellular, wireless LAN, NFC, Bluetooth, USB) for communicating over wireless or wired communications mediums.

Mobile device 10 includes a display 14 such as an organic light emitting diode (OLED) display or liquid crystal diode (LCD) display, a microphone 16 used for voice communications and for receiving spoken commands from a user, a camera 18, a speaker 20 that provides audio output to the user, and one or more buttons 24 for controlling the device. Buttons 24 may be permanent components built into housing or may be virtual buttons, presented on display 14, activated by touching display 14. One or more sensors 22 are positioned on housing to sense various parameters such as contact, temperature, motion, etc.

A processor 40 is coupled to buttons 24, camera 18, microphone 16, sensors 22, and storage medium 43. Processor 40 may be implemented using a general-purpose microprocessor executing a computer program stored in a computer readable storage medium 43 to execute the processes described herein. Processor 40 is also coupled to a communications unit 42 that handles communications between the mobile device 10 and other devices, such as cellular phone calls, NFC communications, Bluetooth, etc. The communications unit 42 is configured to communicate over the wireless network 115. Processor 40 may also execute a number of applications 41 that generate user notifications, such as a calendar application, navigation application, entertainment applications, etc. When a vibratory notification is needed, processor 40 generates command signals to one or more actuators 30 to generate a vibratory notification on mobile device 10.

When the application 215 collects the customer experience management (CEM) data per event (for key performance indicators) as directly experienced/captured by the user at mobile device 10, the application 215 stores the captured customer experience management (CEM) data in the mobile device database 205 in storage medium 43. The application 215 transmits the captured customer experience management (CEM) data in mobile device database 205 to the server 150 for storage in the database 165 to be grouped by geographical location. This same process for collecting customer experience management data at the mobile device database 205 is executed for each of the mobile devices 10A through 10Z, which is from the user equipment perspective (i.e., the user's perspective).

On the other hand, each eNode B (via computer equipment 105) collects the network data per event for the key performance indicators as recognized/captured from the network eNode B perspective, and the network data is stored in a database 110 of the computer equipment 105. The computer equipment 105 transmits its own collected network data to the server 150 to be stored in the database 160.

Once the server 150 receives the network data sent from the computer equipment 105 of the respective eNode Bs and the customer experience management data sent from the respective mobile devices 10, the software application 155 of server 150 is configured to correspond and correlate the network data to the corresponding customer experience management data for the same event (and same KPI).

According to exemplary embodiments, the software application 155 is configured to execute equations in the format of RHS=LHS, where the RHS (i.e., right hand side) of the equation represents an existing KPI and the LHS (i.e., left hand side) of the equation represents the computations for the corresponding customer experience management (CEM) metric that matches and/or corresponds to the existing KPI of the network data. Since the LHS is for customer experience management (CEM) data that is captured at the mobile device 10 and RHS is for network data that is captured at the eNode B, the value of the RHS is expected to be different from the value of the LHS.

Now turning to FIG. 3, a process 300 is illustrated for developing the LHS of the equation and corresponding the LHS to the RHS in accordance with an exemplary embodiment.

At block 305, the server 150 retrieves/receives the customer experience management data per event at the customer experience event level on the mobile device 10 (e.g., mobile device 10A).

At block 310, the server 150 aggregates all the customer experience management data on the same (category of) events over a specific measurement time frame for the mobile device 10 (e.g., mobile device 10A).

At block 315, the server 150 aggregates multiple customers (e.g., mobile devices 10A through 10F) experiences (i.e., multiple customer experience management data) from block 310, where the customer experience management data is collected during the same measurement time frame and the customer experience management data are in the same bin. The bin is a geographic service area exactly as defined in the BAU KPIs, by four sets of latitude and longitude coordinates. For simplicity and explanation purposes, it may be assumed that each eNode B communicates with an area that is in the same bin, although in one case, multiple eNode Bs may cover the same bin. As such, the computer equipment 105A (eNode B) covers a geographical location/area (i.e., bin) that includes mobile devices 10A through 10F as the same bin. The computer equipment 105Z (eNode B) covers a different geographical location/area (i.e., bin) that includes mobile devices 10M through 10Z as one bin.

At block 320, the server 150 may display the CEM metrics of a number of customers in a given bin via user equipment network interface management (UE-NIM) dashboard. The numeric value of the customer experience management data from block 315 is compared against a preset threshold (for a particular event) and the customer experience management data (value) itself is displayed according to the threshold matching of the value, as green, yellow, and/or red levels. The dashboard of the server 150 has the capabilities to permit operators to drill down on any of the displayed metrics such that the customer specific information in block 310 (e.g., for a particular occurrence of the event for a customer of, e.g., mobile device 10A) and also customer event specific information in block 305 (e.g., the summation of all the occurrences of the event for the customer of, e.g., mobile device 10A over a specific measurement time frame) can be visualized for operational purposes.

At block 325, correlation logic (in the application 155) of the server 150 is utilized to compare the RHS (or BAU KPI) with the LHS. The RHS is the network data collected at and obtained from the computer equipment 105A of eNode B, and the LHS is the CEM metric/data as aggregated/averaged in block 315 (for multiple customers of mobile devices 10A through 10F in a bin) and displayed in block 320. If the BAU threshold color is different than the CEM threshold color, then the correlation is shown as red. If the BAU threshold color is the same as the CEM threshold color, then the correlation is considered green. Operational decisions for network or service impairment management is driven from the CEM to BAU KPI matching results per the thresholds.

When there is no current comparable KPI or RHS for a proposed CEM metric on the LHS, then the correlation method in block 320 is not provided.

Note that the application 215 is configured to identify the specific (UE) customer experience management data elements suitable for the LHS computation. As one example, the UE data source and/or probe that may be utilized is the Carrier IQ (CIQ). However, the disclosed CEM metrics, methods, and correlations are not limited to the CIQ specific data elements. Depending on the actual probe implementation, the necessary data elements and their definitions as generated at the UE may be different than specified here using the CIQ example.

FIGS. 4A, 4B, 4C, and 4D (generally referred to as FIG. 4) illustrate a chart 400 of developing the LHS for comparison to the RHS of the equation according to an exemplary embodiment.

The chart 400 shows the metric and KPI for Accessibility, Reliability/Retainability, enhanced Measures of Service (eMOS), and Call Delays (in column 1) next to the four BAU KPIs (in column 2). The chart 300 also shows the corresponding CEM metrics developed in columns 3, 4, and 5. The CEM metrics are displayed and compared against thresholds in column 6. These KPIs are defined in the chart 400 for BAU and VoLTE audio implementation but exemplary embodiments are not limited to the VoLTE example. The example metrics and/or KPIs in chart 400 are discussed below. Examples may be discussed herein for a particular mobile device 10 such as the mobile device 10A, but it is understood that the discussion applies by analogy to all mobile devices 10 connected to their respective eNode B.

Accessibility is the metric or KPI discussed on row 3 of the chart 400. The right hand side (RHS) is the business as usual KPI that is collected from the eNode B by the server 155. For the RHS, the network data for accessibility is retrieved from (and/or sent by) the computer equipment 105A in database 110. On the network side (i.e., from the perspective of the eNode B), the event is for established speech call by the mobile devices 10 in the geographical area of the computer equipment 105A (for a specific time measurement period). On the network side, eNode B receives the speech call attempts (i.e., request) at the computer equipment 105A from the mobile devices 10A through 10F. As calculated by the server 150, the average speech calls established (value) in the network data (of the database 110A) is equal to the speech calls established (calls actually connected (completed) by the computer equipment 105A (such as calls, e.g., connected to other mobile devices 10, land phones, and/or VoIP phones)) divided by the speech calls attempted by the computer equipment 105A. As such, the server 150 has calculated the average established speech calls value for the network data (captured at the computer equipment 105A of eNode B) that corresponds to the accessibility KPI for comparison to the LHS of the equation.

On the left hand side (LHS), there is the same event which is for established speech calls. In this case (as oppose to the network data), each mobile device 10 individually collects its own customer experience management data via the application 215 for this event. For example, mobile device 10A collects (and stores in the mobile device database 205) the speech call attempts and speech calls established, and the mobile device 10A sends this customer experience management data for accessibility KPI to the server 150 (for the same time measurement period as for the network data). The server 150 is configured to calculate an average established speech calls value for the customer experience management data collected from mobile device 10A, by dividing the speech calls established at the mobile device 10A by the speech call attempts at the mobile device 10A. In a scenario where the mobile device 10A may attempt many calls in a basement, near a large building, and/or in a building where signal reception is low, there may only be a few established calls. Accordingly, the mobile device 10A would have a low average established speech calls value for the CEM data as compared to the average established speech calls value for the network data (collected by eNode B via computer equipment 105A). Assuming that the eNode B with computer equipment 105A represents a geographical location which is a bin, the mobile devices 10 all in the same bin (and/or a group of bins) all perform the same operations above, such that each mobile device 10A through 10F sends its respective accessibility customer experience management data to the server 150. The server 150 is configured to gather the average established speech calls value for each mobile device 10A through 10F, and calculate a total average established speech calls value from the customer experience management data for all mobile devices 10A through 10F in the bin during the same time measurement period (column 5).

Now that the total average established speech calls value has been determined for all the mobile devices 10 in the bin, the server 150 compares the total average established speech calls value to a predefined threshold for the accessibility KPI, and provides a color coding according to the total average established speech calls value meeting and/or exceeding the predefined threshold for the accessibility KPI. For example, when the total average established speech calls value equals, exceeds, and/or is 10% or less below the predefined threshold, the color is green. When the total average established speech calls value is below the predefined threshold by 10% to 15%, the color is yellow. When the total average established speech calls value is below the predefined threshold by more than 15%, the color is red. The color coding and percentages may be modified as desired to meet the requirements of the entity.

The server 150 also compares the LHS to the RHS of the equation. For example, total average established speech calls value (LHS) from the CEM data for the bin is correlated to the average established speech calls value for the network data (RHS) for the same bin. Assume that total average established speech calls value (LHS) from the CEM data is 75% while the average established speech calls value for the network data is 90%. The server 150 determines that the customers using the mobile devices 10A through 10F are experiencing a much less customer satisfaction in reality (based on CEM data stored in respective mobile device databases 205) as compared to the network data for accessibility (stored in database 110A of the computer equipment 105A for the eNode B).

Next, retainability/reliability is the metric or KPI discussed on row 4 of the chart 400. The right hand side (RHS) is the business as usual KPI that is collected from the eNode B by the server 155. For the RHS, the network data for retainability is retrieved from (and/or sent by) the computer equipment 105A in database 110. On the network side (i.e., from the perspective of the eNode B), the event is for normal termination of the calls (e.g., by the user selecting the “end call” button (also referred to as radio bearer release) that are established by the mobile devices 10 in the geographical area of the computer equipment 105A (for a specific time measurement period). On the network side, eNode B receives the (number of) radio bearer release messages (normal call termination messages) at the computer equipment 105A from the mobile device 10A through 10F. As calculated by the server 150, the average normal termination calls (value) in the network data (of the database 110A) is equal to the (number of) radio bearer release messages received at the computer equipment 105A divided by the established calls (through and/or by) the computer equipment 105A (such as calls, e.g., connected to other mobile devices 10, land phones, and/or VoIP phones)). As such, the server 150 has calculated the average normal termination of the calls value for the network data (captured at the computer equipment 105A of eNode B) that corresponds to the retainability KPI for comparison to the LHS of the equation.

On the left hand side (LHS), there is the same event which is for normal termination of the calls. In this case (as oppose to the network data), each mobile device 10 individually collects its own customer experience management data via the application 215 for this event. For example, mobile device 10A collects (and stores in the mobile device database 205) calls established and the radio bearer release messages (normal call termination messages), and the mobile device 10A sends this customer experience management data for retainability to the server 150 (for the same time measurement period as for the network data). In one scenario, the user/customer of mobile device 10A originated the call and successfully accessed the wireless network 115 via computer equipment 105A of eNode B to establish the call, but the signal connection had problems. The established call ended and the user did not select the end button to send the release bearer message, but instead the established call was unexpectedly disconnected (because of signal problems). The server 150 is configured to calculate an average normal termination of the calls value for the customer experience management data collected from mobile device 10A, by dividing the (number of) radio bearer release messages sent by the mobile device 10A by the (number of) established calls at the mobile device 10A. Accordingly, the mobile device 10A would have an average normal termination of the calls value for the CEM data, and eNode B has the average normal termination of the calls value for the network data (collected by via computer equipment 105A). Assuming that the eNode B with computer equipment 105A represents a geographical location which is a bin, the mobile devices 10 all in the same bin (and/or a group of bins) all perform the same operations above, such that each mobile device 10A through 10F all send their respective retainability customer experience management data to the server 150. The server 150 is configured to gather the average normal termination of the calls value for each mobile device 10A through 10F, and calculate a total average normal termination of the calls value from the customer experience management data for all mobile devices 10A through 10F in the bin during the same time measurement period (column 5).

Now that the total average normal termination of the calls value has been determined for the mobile devices 10 in the bin, the server 150 compares the total average normal termination of the calls value to a predefined threshold for the retainability KPI, and provides a color coding according to the total average normal termination of the calls value meeting and/or exceeding the predefined threshold for the retainability KPI. For example, when the total average normal termination of the calls value equals, exceeds, and/or is less than 10% below the predefined threshold, the color is green. When the total average normal termination of the calls value is below the predefined threshold by 10% to 15%, the color is yellow. When the total average normal termination of the calls value is below the predefined threshold by more than 15%, the color is red.

The server 150 also compares the LHS to the RHS of the equation for the retainability KPI. For example, total average normal termination of the calls value (LHS) from the CEM data for the bin is correlated to the average normal termination of the calls value for the network data (RHS) for the same bin. Assume that the total average normal termination of the calls value (LHS) from the CEM data is 80% while the average normal termination of the calls value for the network data is 90%. The server 150 determines that the customers using the mobile devices 10A through 10F are experiencing a much less customer satisfaction in reality (based on CEM data stored in respective mobile device databases 205) as compared to the network data for retainability/reliability (stored in database 110A of the computer equipment 105A for the eNode B).

Now turning to the next KPI metric, eMOS is the metric or KPI discussed on row 5 of the chart 400. The right hand side (RHS) is the business as usual KPI that is collected from the eNode B by the server 155. For the RHS, the network data for eMOS is retrieved from (and/or sent by) the computer equipment 105A (the network data stored in database 110). On the network side (i.e., from the perspective of the eNode B), the event is for audio quality index in communicating with the mobile devices 10 measured in the geographical area of the computer equipment 105A (for a specific time measurement period). On the network side, eNode B detects and collects audio quality index metrics which may include collecting at the computer equipment 105A the percent (%) of calls with good voice quality, percent (%) of calls with bad voice quality, and/or percent (%) of calls with one-way audio at the computer equipment 105A, all of which applies to calls established with the mobile device 10A through 10F (in this example). The percent (%) of calls with good voice quality is equal to the number of calls with good voice quality divided by the total number/amount of established calls. The percent (%) of calls with bad voice quality is equal to the number of calls with bad voice quality divided by the total amount of established calls. The percent (%) of calls with one-way audio is equal to the number of calls with one-way audio divided by the total amount of established calls. It is noted that each calculation is multiplied by 100 to obtain percent, as understood by one skilled in the art.

For explanation purposes, the percent (%) of calls with good voice quality is considered as the audio quality index value in this example, but it is understood that each of the calculations above may be performed (separately or collectively) for the audio quality index value. As calculated by the server 150, the average audio quality index value for calls with good voice quality in the network data (of the database 110A) is equal to the number of calls with good voice quality (for all mobile devices 10A through 10F in the geographical area of eNode B with computer equipment 105A in this example) divided by the total number/amount of established calls (through and/or by the computer equipment 105A (such as calls, e.g., connected to other mobile devices 10, land phones, and/or VoIP phones)). As such, the server 150 has calculated the average audio quality index value (for calls with good voice quality) for the network data (at the computer equipment 105A of eNode B) that corresponds to the (network data) eMOS KPI for comparison to the LHS of the equation.

On the left hand side (LHS), there is the same event which is for audio quality index (for calls with good voice quality) of each of the established calls. In this case (as oppose to the network data), each mobile device 10 individually collects its own customer experience management data via the application 215. For example, mobile device 10A collects (and stores in the mobile device database 205) calls established between mobile device 10A and eNode B (with computer equipment 105A in this example); the mobile device 10A sends this customer experience management data for eMOS KPI (audio quality index) to the server 150 (for the same time measurement period as for the network data). The server 150 is configured to calculate an average audio quality index value for calls with good voice quality for the customer experience management data collected from mobile device 10A by dividing the number of calls with good voice quality (individually connected to and established with the mobile device 10A in the geographical area of eNode B with computer equipment 105A in this example) by the total number/amount of established calls of mobile device 10A. In a perfect situation, every established call would have good voice quality.

In one scenario, the user/customer of mobile device 10A has completed establishment of the call (originated and/or received) and successfully accessed the wireless network 115 via computer equipment 105A of eNode B, but the signal connection had problems. An established call with good quality does not have the following defects while an established call with bad voice quality has the following defects: the established call with bad voice quality may have mouth to ear delay, jitter (where jitter is a variation in packet transit delay caused by queuing, contention, and serialization effects on the path through the network), a packet loss rate above a predefined packet loss amount, and a long voice interruption (voice interruption above a predefined amount). Note that these same defects are utilized and collected in the network data for calculating the audio quality index at the eNode B side (i.e., at computer equipment 105A) but the eNode B does not collect the defects actually experienced at the mobile device itself (i.e., at the handset) but recognizes the defects detectable at the computer equipment 105A. Continuing the example scenario with mobile device 10A, the mobile device 10A has an average audio quality index value (for calls with good voice quality) for the CEM data, to be compared to the average audio quality index value for calls with good voice quality for the network data (collected by eNode B via computer equipment 105A). Assuming that the eNode B with computer equipment 105A represents a geographical location which is a bin, the mobile devices 10 all in the same bin (and/or a group of bins) all perform the same operations above, such that each mobile device 10A through 10F all send their respective audio quality index customer experience management data to the server 150. The server 150 is configured to gather the average audio quality index value (for calls with good voice quality) for each mobile device 10A through 10F, and calculate a total average audio quality index value for calls with good voice quality from the customer experience management data for all mobile devices 10A through 10F in the bin during the same time measurement period (row 5, column 5).

Now that the total average audio quality index value for the calls with good voice quality has been determined for the mobile devices 10 in the bin, the server 150 compares the total average audio quality index value of the calls with good voice quality to a predefined threshold for the audio quality index value (of the calls with good voice quality) eMOS KPI, and provides a color coding according to the total average audio quality index value (of the calls with good voice quality) meeting and/or exceeding the predefined threshold for the eMOS KPI (audio quality index). For example, when the total average audio quality index value equals, exceeds, and/or is less than 10% below the predefined threshold for the eMOS KPI (audio quality index), the color is green. When the total average of the audio quality index value (of the calls with good voice quality) is below the predefined threshold for the eMOS KPI (audio quality index) by 10% to 15%, the color is yellow. When the total average the audio quality index value (of the calls with good voice quality) is below the predefined threshold for the eMOS KPI (audio quality index) by more than 15%, the color is red.

The server 150 also compares the LHS to the RHS of the equation for the eMOS KPI (audio quality index) KPI for the same event. For example, total average audio quality index value (of the calls with good voice quality) (LHS) from the CEM data for the bin is correlated to the average the audio quality index value (of the calls with good voice quality) for the network data (RHS) for the same bin. Assume that total audio quality index value (of the calls with good voice quality) (LHS) from the CEM data is 80% while the average audio quality index value (of the calls with good voice quality) for the network data is 90%. The server 150 determines that the customers using the mobile devices 10A through 10F are experiencing a much less customer satisfaction in reality (based on CEM data stored in respective mobile device databases 205) as compared to the network data for the audio quality index value (of the calls with good voice quality) (stored in database 110A of the computer equipment 105A for the eNode B).

Now turning to the next KPI metric, call delays is the metric or KPI discussed on row 6 of the chart 400. The right hand side (RHS) is the business as usual KPI that is collected from the eNode B by the server 155. For the RHS, the network data for eMOS is retrieved from (and/or sent by) the computer equipment 105A (the network data stored in database 110). On the network side (i.e., from the perspective of the eNode B), the event is for call delays in communicating with the mobile devices 10 measured in the geographical area of the computer equipment 105A (for a specific time measurement period). On the network side, eNode B detects and collects call delays metrics which may include collecting at the computer equipment 105A the number of mobile originated (MO) post-dial delays (where the MO post-dial delay is greater than a predefined time), the number of mobile originated (MO) call post-ringing delays (where the MO call post-ringing delay is greater than a predefined time), the number of mobile originated call complete setup delays (where the MO call complete setup delay is greater than a predefined time), and/or the mobile terminated (MT) post-answer delay (where the MT post answer delay is greater than a predefined time), all of which applies to calls regarding the mobile device 10A through 10F (in this example). Mobile originated post-dial delay is the time from dialing the last digit (at mobile device 10) to the time a caller hears ringing (back at mobile device 10). From the network side at the eNode B, the computer equipment 105A recognizes and collects the (start) time from when the computer equipment 105A receives the last digit from mobile device 10 until the (end) time that computer equipment 105A sends the ringing signal back to the same mobile device 10. This post-dial delay time collected as the network data at the eNode B by the computer equipment 105A is expected to be shorter that the post-dial delay time collected at the mobile device 10A because the ringing signal still has to travel back to the mobile device 10 that originated the call.

For explanation purposes, the number of mobile originated (MO) post delays (where the MO post dial delay is greater than a predefined time) is being considered as the call delays KPI, but it is understood that each of the calculations may be performed. As calculated by the server 150, the average number of call delays value for mobile originated (MO) post-dial delays (where each MO post-dial delay is greater than a predefined time) in the network data (of the database 110A) is equal to the number of (occurrences) of mobile originated (MO) post-dial delays (where the MO post-dial delay is greater than the predefined time for all mobile devices 10A through 10F in the geographical area of eNode B with computer equipment 105A in this example) divided by the total number/amount of established calls for all mobile devices 10A through 10F in the geographical area of eNode B (through and/or by the computer equipment 105A (such as calls, e.g., connected to other mobile devices 10, land phones, and/or VoIP phones)). As such, the server 150 has calculated the average number of call delays value for mobile originated (MO) post-dial delays for the network data (at the computer equipment 105A of eNode B) that corresponds to the (network data) call delays KPI for comparison to the LHS of the equation.

On the left hand side (LHS), there is the same event which is for call delays in communicating with the mobile devices 10 measured in the geographical area of the computer equipment 105A (for the same specific time measurement period as network data). In this case (as oppose to the network data), each mobile device 10 individually collects its own customer experience management data via the application 215. For example, mobile device 10A collects (and stores in the mobile device database 205) call delays between mobile device 10A and eNode B (with computer equipment 105A in this example); the mobile device 10A sends this customer experience management data for call delays (for mobile originated (MO) post-dial delays) KPI to the server 150 (for the same time measurement period as for the network data). The server 150 is configured to calculate an average call delays value for mobile originated (MO) post-dial delays for the customer experience management data collected from mobile device 10A which is equal to the number of (occurrences) of mobile originated (MO) post-dial delays (detected when the MO post-dial delay is greater than the predefined time for calls originated by the mobile device 10A in the geographical area of eNode B with computer equipment 105A in this example) divided by the total number/amount of mobile originated calls established for mobile device 10A (individually connected to and originated by the mobile device 10A in the geographical area of eNode B with computer equipment 105A in this example).

In one scenario, the user/customer of mobile device 10A has originated/dialed a call to successfully access the wireless network 115 via computer equipment 105A of eNode B, but there are mobile originated (MO) post-dial delay problems. For example, the user has selected the last digit for a call and there is a post-dial delay greater than the predefined delay before the user hears a ringing tone at the mobile device 10. Note that the application 215 (in respective mobile devices 10) and computer equipment 105 are each configured with individual counters to count the respective occurrences (i.e. number) of each event that is needed as a metric for respective KPIs (discussed herein), as understood by one skilled in the art. Continuing the example scenario with mobile device 10A, the mobile device 10A has its average call delays value for mobile originated (MO) post-dial delays for the customer experience management data, to be compared (via server 150) to the average call delays value for mobile originated (MO) post-dial delays for the network data (collected by eNode B via computer equipment 105A). Assuming that the eNode B with computer equipment 105A represents a geographical location which is a bin, the mobile devices 10 all in the same bin (and/or a group of bins) all perform the same operations above, such that each mobile device 10A through 10F all send their respective average call delays (for mobile originated (MO) post-dial delays) customer experience management data (collected individually from mobile devices 10) to the server 150. The server 150 is configured to gather the average call delays (for mobile originated (MO) post-dial delays) for each mobile device 10A through 10F, and calculate a total average call delays (for mobile originated (MO) post-dial delays) from all the customer experience management data for all mobile devices 10A through 10F in the bin during the same time measurement period (row 6, column 5).

Now that the total average call delays (for mobile originated (MO) post-dial delays) has been determined for the mobile devices 10 in the bin, the server 150 compares the total average call delays (for mobile originated (MO) post-dial delays) to a predefined threshold for the call delays (for mobile originated (MO) post-dial delays) KPI, and provides a color coding according to the total average call delays value (for mobile originated (MO) post-dial delays) meeting and/or exceeding the predefined threshold for the call delays KPI (mobile originated (MO) post-dial delays). For example, when the total average call delays value equals, exceeds, and/or is less than 10% below the predefined threshold for the call delays KPI (for mobile originated (MO) post-dial delays), the color is green. When the total average of call delays value (for mobile originated (MO) post-dial delays) is below the predefined threshold for the call delays KPI (mobile originated (MO) post-dial delays) by 10% to 15%, the color is yellow. When the total average call delays value (for mobile originated (MO) post-dial delays) is below the predefined threshold for the call delays KPI (audio quality index) by more than 15%, the color is red.

The server 150 also compares the LHS to the RHS of the equation for the call delays KPI (for mobile originated (MO) post-dial delays). For example, total average call delays (for mobile originated (MO) post-dial delays) (LHS) from the CEM data for the bin is correlated to the average call delays value (for mobile originated (MO) post-dial delays) for the network data (RHS) for the same bin. Assume that total call delays value (for mobile originated (MO) post-dial delays) (LHS) from the CEM data is 80% while the average call delays value (for mobile originated (MO) post-dial delays) for the network data is 90%. The server 150 determines that the customers using the mobile devices 10A through 10F are experiencing a much less customer satisfaction in reality (based on CEM data stored in respective mobile device databases 205) as compared to the network data for the call delays value (for mobile originated (MO) post-dial delays) (stored in database 110A of the computer equipment 105A for the eNode B).

FIG. 5 is a flowchart of a process 500 for corresponding network collected metrics to user equipment collected metrics in an exemplary embodiment. Reference can be made to FIGS. 1-4 along with FIG. 6 discussed below. The server 150 may include features (such as processors 610, memory 620, etc.) from a computer 600 discussed in FIG. 6. The process 500 may be implemented by processor 610 in response to computer program code stored in storage medium 620. The process begins at block 505 where processor 610 of the server 150 retrieves/receives customer experience management (CEM) data (for an event) obtained directly from user computing devices (such as mobile devices 10) of customers in a geographical area (e.g., a bin). The customer experience management data has been stored at the computing devices (e.g., in respective mobile device databases 205 in mobile devices 10). The computing devices (mobile devices 10) wirelessly operate on wireless communication network 115.

At block 510, the processor 610 of the server 150 is configured to average the customer experience management data individually obtained from the computing devices (the individual mobile devices 10) to determine a total customer experience management data average value for the bin corresponding to the particular event.

At block 515, the processor 610 of the server 150 retrieves network data (for the event) obtained from a node (e.g., computer equipment 105 of eNode B) in the geographical area (same bin) on the wireless communication network 115. The network data has been stored (in the database 110) at the eNode B.

At block 520, the processor 610 of the server 150 averages the network data obtained from the node to determine a network data average value for the network data (corresponding to the same event for the same time measurement period) obtained from the individual mobile device databases 205 stored in respective mobile devices 10.

At block 525, the processor 610 of the server 150 correlates the network data average value to the customer experience management data average value to determine a relationship between the network data average value and the customer experience management data average value for the event.

The node (e.g., the computer equipment 105 in eNode B) includes a transceiver that communicates with the computing devices (mobile devices 10) on the wireless communication network 115. The network data average value for the event corresponds to operations executed by the node (eNode B) on behalf of the computing devices. The customer experience management data for the event corresponds to processes executed on the computing devices respectively (e.g., executed individually by the mobile devices 10), and the processes executed on the computing devices execute independently of the operations executed by the node. For example, the user of mobile device 10 case initiate a call via processor 40 by sending an initiate call signal (invite) to the eNode B, and/or the user of mobile device 10 can end (via processor 40) a call by selecting an end call button that sends an end call signal to the eNode B. Although the mobile device 10 works in conjunction with eNode B, there are processes, actions, and operations that are executed (and stored exclusively) specifically on the mobile device 10.

The event is identical for both the network data and the customer experience management data. The network data is from a perspective at the node (e.g., the network data is collected by, stored on, and taken from the point of view of the eNode B via computer equipment 105). On the other hand, the customer experience management data is from a perspective of the computing devices (e.g., the CEM data is collected by, stored on, and taken from the point of view of the individual mobile device 10 (i.e., at the user equipment or handset)).

Correlating (by the server 150) the network data average value to the customer experience management data average value to determine the relationship between the network data average value and the customer experience management data average value includes: determining when the network data average value and the customer experience management data average value are equal to and/or has a difference value (e.g., subtract one value from the other value and then take the absolute value) within a first predefined amount corresponding to a first color (e.g., green); determining when the network data average value and the customer experience management data average value have a different value between the first predefined amount and a second predefined amount corresponding to a second color (e.g., yellow), in which the second predefined amount is greater than the first predefined amount; and determining when the network data average value and the customer experience management data average value have a difference value greater the second predefined amount corresponding to a third color (e.g., red).

The network data average value and the customer experience management data average value for the event correspond to a key performance indicator. For example, the network data and customer experience management data are collected respectively for the accessibility KPI, retainability KPI, eMOS (signal reliability) KPI, and call delays KPI, and the network data average value and the CEM average value are determined for each KPI.

There are various benefits in utilizing the features discussed herein. First, one benefit is the quantification via the proposed metrics of the actual customer experience of the services and network capabilities as experienced by the customer. Second, based on the actual metrics and their interpretation, the service provider entity (such as, e.g., AT&T®) may choose to interact proactively and/or in a planned manner with the concerned customers and message the customer in a manner that would lead to uplifted perceptions and social media feedback to raise the overall NPS metrics for the entity (AT&T®). Third, by correlating CEM metrics to BAU KPIs (e.g., network data collected by the network (eNode B)), the entity's operations are able to take timelier and effective impairment management actions, to improve the services and cost basis for network operations. Four, a flexible framework for correlating user experience and network operations along with the development of actionable alarms, ticketing, diagnostics, and restoration both manual and automated.

FIG. 6 illustrates an example of the computer 600 having capabilities, which may be included in exemplary embodiments. Various methods, procedures, circuits, elements, and techniques discussed herein may incorporate and/or utilize the capabilities of the computer 600. One or more of the capabilities of the computer 660 may be utilized to implement, to incorporate, to connect to, and/or to support any element discussed herein (as understood by one skilled in the art) in FIGS. 1-5. For example, the mobile devices 10, the computer equipment 105, and the server 150 may incorporate any of the hardware and software features discussed in FIG. 6.

Generally, in terms of hardware architecture, the computer 600 may include one or more processors 610, computer readable storage memory 620, and one or more input and/or output (I/O) devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a data signal processor (DSP), or an auxiliary processor among several processors associated with the computer 600, and the processor 610 may be a semiconductor based microprocessor (in the form of a microchip) or a microprocessor.

The computer readable memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the computer readable memory 620 may include one or more separate programs, each of which comprises an ordered listing of executable instructions for implementing logical functions. The software in the memory 620 includes a suitable operating system (O/S) 650, compiler 640, source code 630, and one or more applications 660 of the exemplary embodiments. As illustrated, the application 660 comprises numerous functional components for implementing the features, processes, methods, functions, and operations of the exemplary embodiments. The application 660 of the computer 600 may represent numerous applications, agents, software components, modules, interfaces, controllers, etc., as discussed herein but the application 660 is not meant to be a limitation.

The operating system 650 may control the execution of other computer programs, and provides scheduling, input-output control, file and data management, memory management, and communication control and related services.

The application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as (a) an object oriented programming language, which has classes of data and methods, or (b) a procedure programming language, which has routines, subroutines, and/or functions.

The I/O devices 670 may include input devices (or peripherals) such as, for example but not limited to, a mouse, keyboard, scanner, microphone, camera, etc. Furthermore, the I/O devices 670 may also include output devices (or peripherals), for example but not limited to, a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or an intranet. The I/O devices 670 may be connected to and/or communicate with the processor 610 utilizing Bluetooth connections and cables (via, e.g., Universal Serial Bus (USB) ports, serial ports, parallel ports, FireWire, HDMI (High-Definition Multimedia Interface), etc.).

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable storage medium for use by or in connection with any computer related system or method.

The application 660 can be embodied in any computer-readable medium for use by or in connection with an instruction execution system, apparatus, server, or device, such as a computer-based system, processor-containing system, or other system that can fetch the instructions from the instruction execution system, apparatus, or device and execute the instructions.

In exemplary embodiments, where the application 660 is implemented in hardware, the application 660 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the exemplary embodiments can be in the form of processor-implemented processes and devices for practicing those processes, such as processor 40. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

What is claimed is:

1. A method of corresponding network collected metrics to user equipment collected metrics, the method comprising:
retrieving customer experience management data for an event obtained directly from computing devices of customers in a geographical area, the customer experience management data having been stored at the computing devices;
wherein the computing devices wirelessly operate on a wireless communication network;
averaging the customer experience management data obtained from the computing devices to determine a customer experience management data average value;
retrieving network data for the event obtained from a node in the geographical area on the wireless communication network, the network data having been stored at the node;
averaging the network data obtained from the node to determine a network data average value for the network data; and
correlating the network data average value to the customer experience management data average value to determine a relationship between the network data average value and the customer experience management data average value for the event.

2. The method of claim 1, wherein the node includes a transceiver that communicates with the computing devices on the wireless communication network; and
wherein the network data average value for the event corresponds to operations executed by the node on behalf of the computing devices.

3. The method of claim 2, wherein the customer experience management data for the event corresponds to processes executed on the computing devices respectively; and
wherein the processes executed on the computing devices execute independently of the operations executed by the node.

4. The method of claim 1, wherein the event is identical for both the network data and the customer experience management data.

5. The method of claim 1, wherein the network data is from a perspective at the node.

6. The method of claim 1, wherein the customer experience management data is from a perspective of the computing devices.

7. The method of claim 1, wherein correlating the network data average value to the customer experience management data average value to determine the relationship between the network data average value and the customer experience management data average value includes:
determining when the network data average value and the customer experience management data average value are equal to one another or have a difference value within a first predefined amount corresponding to a first color;
determining when the network data average value and the customer experience management data average value have the difference value between the first predefined amount and a second predefined amount corresponding to a second color, the second predefined amount is greater than the first predefined amount; and
determining when the network data average value and the customer experience management data average value have the difference value greater the second predefined amount corresponding to a third color.

8. The method of claim 1, wherein the network data average value and the customer experience management data average value for the event correspond to a key performance indicator.

9. An apparatus comprising:
a processor; and
memory comprising computer-executable instructions that, when executed by the processor, cause the processor to perform operations, the operations comprising:
retrieving customer experience management data for an event obtained directly from computing devices of customers in a geographical area, the customer experience management data having been stored at the computing devices;
wherein the computing devices wirelessly operate on a wireless communication network;
averaging the customer experience management data obtained from the computing devices to determine a customer experience management data average value;
retrieving network data for the event obtained from a node in the geographical area on the wireless communication network, the network data having been stored at the node;
averaging the network data obtained from the node to determine a network data average value for the network data; and
correlating the network data average value to the customer experience management data average value to determine a relationship between the network data average value and the customer experience management data average value for the event.

10. The apparatus of claim 9, wherein the node includes a transceiver that communicates with the computing devices on the wireless communication network; and
wherein the network data average value for the event corresponds to node operations executed by the node on behalf of the computing devices.

11. The apparatus of claim 10, wherein the customer experience management data for the event corresponds to processes executed on the computing devices respectively; and
wherein the processes executed on the computing devices execute independently of the node operations executed by the node.

12. The apparatus of claim 9, wherein the event is identical for both the network data and the customer experience management data.

13. The apparatus of claim 9, wherein the network data is from a perspective at the node.

14. The apparatus of claim 9, wherein the customer experience management data is from a perspective of the computing devices.

15. The apparatus of claim 9, wherein correlating the network data average value to the customer experience management data average value to determine the relationship between the network data average value and the customer experience management data average value includes:
determining when the network data average value and the customer experience management data average value are equal to one another or have a difference value within a first predefined amount corresponding to a first color;
determining when the network data average value and the customer experience management data average value have the difference value between the first predefined amount and a second predefined amount corresponding to a second color, the second predefined amount is greater than the first predefined amount; and
determining when the network data average value and the customer experience management data average value have the difference value greater the second predefined amount corresponding to a third color.

16. The apparatus of claim 9, wherein the network data average value and the customer experience management data average value for the event correspond to a key performance indicator.

17. A computer program product, tangibly embodied on a computer readable medium, for corresponding network collected metrics to user equipment collected metrics, the computer program product including instructions that, when executed by a processor, cause the processor to perform operations comprising:
retrieving customer experience management data for an event obtained directly from computing devices of customers in a geographical area, the customer experience management data having been stored at the computing devices;
wherein the computing devices wirelessly operate on a wireless communication network;
averaging the customer experience management data obtained from the computing devices to determine a customer experience management data average value;
retrieving network data for the event obtained from a node in the geographical area on the wireless communication network, the network data having been stored at the node;
averaging the network data obtained from the node to determine a network data average value for the network data; and
correlating the network data average value to the customer experience management data average value to determine a relationship between the network data average value and the customer experience management data average value for the event.

18. The computer program product of claim 17, wherein the node includes a transceiver that communicates with the computing devices on the wireless communication network; and
wherein the network data average value for the event corresponds to operations executed by the node on behalf of the computing devices.

19. The computer program product of claim 18, wherein the customer experience management data for the event corresponds to processes executed on the computing devices respectively; and
wherein the processes executed on the computing devices execute independently of the operations executed by the node.

20. The computer program product of claim 17, wherein the event is identical for both the network data and the customer experience management data.
